(19) United States
(12) Patent Application Publication
(10) Pub. No.: US 2018/0320969 A1
(43) Pub. Date: Nov. 8, 2018

(54) DEVICE FOR CONTROLLING THE TEMPERATURE OF OBJECTS AND METHOD FOR CONTROLLING A DEVICE FOR CONTROLLING THE TEMPERATURE OF OBJECTS

(71) Applicant: EISENMANN SE, Boeblingen (DE)

(72) Inventor: Eduard Karl HACK, Holzgerlingen (DE)

(21) Appl. No.: 15/764,920

(22) PCT Filed: Oct. 6, 2016
(86) PCT No.: PCT/EP2016/073842

§ 371 Date: Mar. 30, 2018

(30) Foreign Application Priority Data
Oct. 6, 2015 (DE) 10 2015 012 848.5

(51) Int. Cl. F26B 21/10; F26B 23/02

(52) U.S. Cl. CPC F26B 21/10; F26B 2210/12; F26B 23/02

(57) ABSTRACT

A device for controlling the temperature of objects, in particular for drying coated vehicle bodies, and method for controlling the device, the device having a temperature control chamber and a cooling region connected to the temperature control chamber, a temperature control device for generating temperature control air, a control apparatus, and a heat exchanger. The heat exchanger has an outside air inlet, a hot air inlet connected to the cooling region and/or the temperature control device, and a cooling air outlet connected to the cooling region, and the control apparatus is designed to control the temperature of the outside air supplied via the outside air inlet using hot air supplied via the hot air inlet.

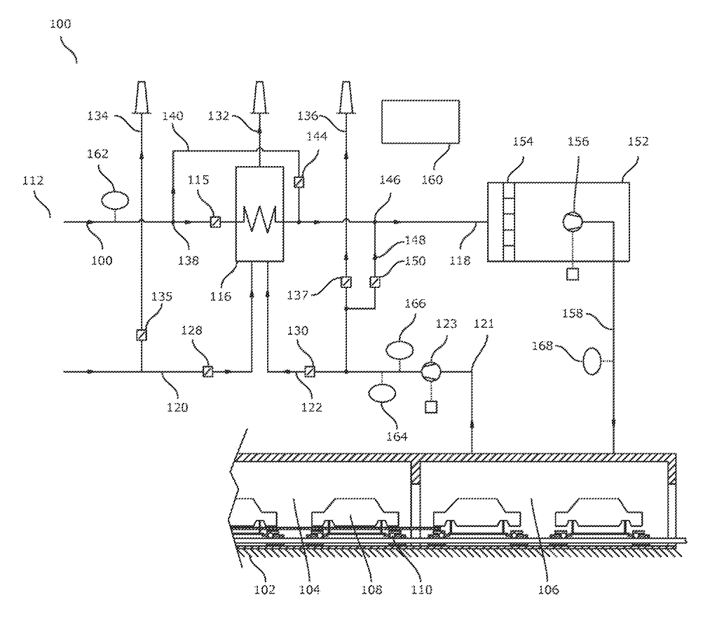

### BACKGROUND OF THE INVENTION

### 1. Field of the Invention

The invention relates to a device for controlling the temperature of objects, in particular for drying coated vehicle bodies, having a temperature control space and a cooling region which is connected to the temperature control space, a temperature control device for generating temperature control air, a control device and a heat exchanger. Moreover, the invention relates to a method for controlling a device of this type for controlling the temperature of objects.

### 2. Description of the Prior Art

In the following text, the invention will be described predominantly with reference to vehicle bodies as objects. However, the invention also relates to devices for other objects, the temperature of which has to be controlled in a production process. The term “temperature control” is understood to mean bringing about a temperature change of an object. This can be a temperature increase or a temperature reduction. “Temperature controlled air” or “temperature control air” is understood to mean air which is at the temperature which is required for controlling the temperature of the object.

In the automotive industry, vehicle bodies are frequently heated, in order to remove moisture from the vehicle bodies or to dry a coating of a vehicle body of this type. It goes without saying that other moist objects than vehicle bodies or the coatings of other objects can also be dried.

The term “drying” is to include all operations, in which the coating of vehicle bodies, in particular a paint, is hardened/cured, whether by way of expulsion of solvents or by way of cross-linking of the coating substance or the like.

Temperature control or drying systems are usually parts of painting or coating systems, are connected downstream of the latter with regard to the process control, and serve to dry, burn in and/or harden/cure coatings or adhesives on objects. On account of the size of the objects and the required temperatures, a temperature control system of this type requires considerable quantities of energy. After a temperature control process has been carried out, the temperature controlled objects are usually at an elevated temperature and have to be cooled to manageable temperatures for further processing. In the present case a “manageable temperature” is understood to mean a temperature, at which workers can handle the object without risk and further safety measures with regard to the temperature. A manageable temperature is usually a temperature of a shop, in which the further processing is to take place. Filtered external air can be fed in, for example, for the reduction of the temperature. Depending on the external temperature level, more or less rapid cooling of the coated objects then takes place. Problems can occur, however, if the external temperature is particularly low and is, for example, around freezing point or below it. Then, either excessive cooling of the overall cooling region which is provided for the temperature reduction takes place, or the available volumetric flow is too low.

### SUMMARY OF THE INVENTION

It is an object of the invention to specify a device for controlling the temperature of objects, in particular for drying coated vehicle bodies, having an energy-optimized cooling region.

The object is achieved by way of a device for controlling the temperature of objects as claimed in independent claim 1. The object is also achieved by way of a method for controlling a device for controlling the temperature of objects as claimed in independent claim 10. Further refinements of the invention are specified in the corresponding dependent claims.

The device according to the invention for controlling the temperature of objects, in particular for drying coated vehicle bodies, has a temperature control space and a cooling region which is connected to the temperature control space, a temperature control device for generating temperature control air, a control device and a heat exchanger. It is provided according to the invention that the heat exchanger has an external air feed line, a warm air feed line which is connected to the cooling region and/or the temperature control device, and a cooling air discharge line which is connected to the cooling region. Furthermore, the control device is set up to control the temperature of external air which is fed in via the external air feed line by way of warm air which is fed in via the warm air feed line. It is therefore possible to feed external air to the heat exchanger and to control the temperature by means of warm air. The warm air can either come from the cooling region itself, to which the external air is to be fed. As an alternative or in addition, the warm air can also be formed by a temperature control device. The temperature control device can be a temperature control device which is present in any case in the device for controlling the temperature of objects, for example for generating temperature control air for the temperature control space. The temperature control device can be understood to mean, for example, a thermal afterburning device or a heating register for individual zones of the temperature control device. The control device can bring about the temperature control of the external air in the heat exchanger, for example, by virtue of the fact that it changes the ratio of a volumetric flow which comes from the cooling region and a volumetric flow which comes from the temperature control device. It is possible in this way to bring about cooling of the objects which are conveyed out of the temperature control space into the cooling region, in a way which is optimized in terms of energy. The heating of the external air which is necessary for this purpose in some circumstances can take place by way of cooling region waste air with the warm air which comes from a temperature control device being mixed in. Therefore, no energy from a technical supply network of the device for controlling the temperature of objects is required.

One particularly advantageous development of the invention results from the fact that the heat exchanger has a bypass line which connects the external air feed line and the cooling air discharge line. By means of the bypass line, the external air can be guided around the heat exchanger directly into the cooling region. For this purpose, the bypass line can have a control valve. Therefore, the bypass line can be opened or closed by way of the control device depending on the requirement.

It can be provided in one embodiment of the invention that the controller is set up to actuate the bypass line in a manner which is dependent on the temperature of the external air. In this way, the function of the heat exchanger can be disabled at suitable temperatures, such as in the case of correspondingly high external temperatures, and the external air can be introduced without temperature control into the cooling region of the device for controlling the temperature of objects. At correspondingly lower external temperatures, in contrast, the heat exchanger can perform its function completely and can bring the external air to the desired temperature which is suitable for the cooling region. A possible limit, at which opening of the bypass line can take place, can lie, for example, in a range of from 15° C. to 17° C. external temperature.

One development of the invention can provide that the temperature control air is a pure gas of a thermal afterburning operation, cooling region waste air, direct temperature control space waste air and/or temperature control space waste air which is temperature controlled by way of the temperature control device. In particular, mixing of the abovementioned temperature control air sources can also take place in order to generate suitable temperature control of the external air.

One embodiment can provide that the device for controlling the temperature of objects has a feed air system for feeding feed air to the cooling region, the feed air system being connected to the cooling air discharge line of the heat exchanger. For example, filtering of the external air which is to be fed to the cooling region and possibly cooling can take place in the feed air system.

In this context, it can be provided that the feed air system has a fan and/or a filter.

In one development of the invention, the heat exchanger can be configured as a plate heat exchanger. This design makes a satisfactory heat transfer possible between two gaseous media with simultaneously inexpensive implementation and flexible design of the flow guidance.

It can be provided in one embodiment that the heat exchanger has a temperature control air discharge line, via which the temperature control air which is fed to the heat exchanger can be output.

The method according to the invention for controlling a device for controlling the temperature of objects can be used in a device which has a temperature control space, a cooling region which is connected to the temperature control space, a temperature control device for generating temperature controlled temperature control space air, and a heat exchanger. In particular, this can be a device as described above in different embodiments and developments. The heat exchanger has an external air feed line, a warm air feed line which is connected to the cooling region and the temperature control device, and a cooling air discharge line which is connected to the cooling region. The method comprises the following steps: determining of a temperature of the external air; setting of an external air volumetric flow through the cooling air discharge line, which external air volumetric flow can be temperature controlled by the heat exchanger; and setting of a volumetric flow ratio between the volumetric flow which flows from the cooling region into the heat exchanger and the volumetric flow which flows from the temperature control device into the heat exchanger in a manner which is dependent on the temperature of the external air. The method therefore makes temperature control of the external air volumetric flow possible in an inexpensive and simple way, which temperature control takes place in a suitable manner depending on the temperature of the external air.

One development of the method according to the invention can provide that the external air volumetric flow is deflected around the heat exchanger through a bypass line in a manner which is dependent on the temperature of the external air. It can be provided in one embodiment, for example, that the step of deflecting comprises complete deflection at a threshold temperature. Therefore, depending on the level of the external temperature, the external air can be guided through the heat exchanger or past the heat exchanger into the cooling region of the device in order to control the temperature of objects. If a threshold of the external temperature is exceeded, for example, the external air can be guided completely through the bypass line into the cooling region without flowing through the heat exchanger. A threshold temperature of this type can lie, for example, in a range of from 15° C. to 17° C.

### BRIEF DESCRIPTION OF THE DRAWINGS

In the following text, one exemplary embodiment of the invention will be described in greater detail using a drawing which shows a diagrammatic illustration of a dryer for vehicle bodies.

### DESCRIPTION OF PREFERRED EXEMPLARY EMBODIMENTS

The single figure shows a diagrammatic illustration of one embodiment of a device according to the invention for controlling the temperature of objects in the form of a dryer 100. The dryer 100 has a thermally insulated dryer housing 102, in which a dryer space 104 is accommodated. The dryer space 104 is adjoined by a cooling region 106. By way of example, motor vehicle bodies 108 are heated in the dryer 100 after a coating process, in order to dry the motor vehicle bodies 108 or a coating or adhesive bond which is applied to them. If reference is made here or in the following text to “drying”, this means all processes, in which the coating of the vehicle body, in particular a paint, can be hardened/cured. This can take place, for example, by way of expulsion of water or of solvents or by way of cross-linking of the coating substance.

In the dryer space 104, the motor vehicle bodies 108 are conveyed through continuously by means of a conveying system 110 (not described in greater detail here) and pass after the drying process which takes place in the dryer space 104 into the cooling region 106, in which the temperature-controlled objects, that is to say the motor vehicle bodies 108 here, are brought to a manageable temperature again.

For this cooling operation, the cooling region 106 is fed with external air 112. The external air 112 which is removed, for example, from the outer region of the dryer 100 is fed to a heat exchanger 116 via an external air feed line 114.

In the present embodiment, the heat exchanger 116 is configured as a plate heat exchanger. In addition to the particularly advantageous design of a plate heat exchanger, however, it goes without saying that other designs are also possible, such as spiral heat exchangers. The external air 112 which can be conveyed in via the external air feed line 114 and the volumetric flow of which can be controlled by means of a control valve 115 is conveyed through the heat exchanger 116 into a cooling air discharge line 118. A heat exchange from the heat exchanger 116 to the external air 112 takes place in the heat exchanger 116. To this end, the heat exchanger 116 has a first warm air feed line 120 and a second warm air feed line 122. The first warm air feed line 120 conveys pure gas 124 which can be generated, for example, in a thermal afterburning operation to the heat exchanger 116. By means of a waste air fan 123, cooling region waste air 126 is conveyed from the cooling region 106 via a cooling region waste air line 121 to the second warm air feed line 122 and into the heat exchanger 116. A first warm air control valve 128 controls the pure gas volumetric flow which passes into the heat exchanger 116. Together with or as an alternative to the waste air fan 123, a second warm air control valve 130 controls the cooling region waste air volumetric flow which passes into the heat exchanger 116. After flowing through the heat exchanger 116, the warm air is discharged via a temperature control air discharge line 132, for example, to the surroundings. In addition to the possibility of feeding the pure gas 124 and the cooling region waste air 126 to the heat exchanger 116, there is respectively the possibility of discharging the pure gas 124 and the cooling region waste air 126 to the surroundings. The pure gas 124 can be output via a pure gas discharge line 134 and the cooling region waste air 126 can be output via a cooling region waste air line 136 to the surroundings, in each case in a manner which is controlled via control valves 135, 137.

A first bypass branch 138, at which a bypass line 140 branches off, is situated in the external air feed line 114 to the heat exchanger 116. The bypass line 140 bridges the heat exchanger 116 and opens into the cooling air discharge line 118 at a second bypass branch 142. The bypass line 140 has a bypass control valve 144 which can close and open the bypass line 140. The cooling air discharge line 118 has a further branch 146, into which a line 148 which branches off from the cooling region waste air line 136 opens by way of a control valve 150.

The cooling air discharge line 118 opens into a feed air system 152, in which a filtering means 154, possibly a cooling means (not depicted) and a feed air fan 156 are arranged. By means of the feed air fan 156, the temperature-controlled external air 118 is fed to the cooling region 106 via a cooling region feed line 158.

The dryer 100 has a control device 160. In order to keep the figure clear, no individual control lines are illustrated. The control device 160 is connected to the control valves 115, 128, 130, 135, 137, 150, 144 and to the fans 123, 156, and actuates them depending on the layout of the overall system. Therefore, individual control valves or all control valves can be actuable, for example, by motor. The rotational speed of the fans can likewise be controlled or regulated. Furthermore, temperature sensors 162, 164 are provided in the external air feed line 114 and the second warm air feed line 122, and volumetric flow sensors 166, 168 are provided in the cooling region waste air line 121 and the cooling region feed line 158, which sensors supply corresponding data to the control device 160.

During operation, the dryer 100 works as follows:

Cooling region waste air 126 is removed from the cooling region 106 via the cooling region waste air line 121, the temperature of the cooling region waste air 126 is determined via the sensor 164 and the volumetric flow of the cooling region waste air 126 which is produced is determined via the volumetric flow sensor 166, and communicated to the control device 160.

A first part of the air volume which is removed from the cooling region 106 can possibly be fed to the cooling region 106 again as recirculated air via the line 148. This can be advantageous, in particular, during startup operation. A second part is fed to the surroundings via the cooling region waste air line 136. A third part can be fed to the heat exchanger 116 via the second warm air feed line 122 and can be used there to heat the external air 112 which is fed in via the external air feed line 114. The second part of the cooling region waste air 126 which is output to the recirculated air has to be supplemented again via the fresh air feed. The control device 160 determines the temperature of the external air 112 via the temperature sensor 162. If the determined temperature of the external air 112 is below a limit value, for example is lower than or equal to 17° C., the external air 112 to be fed in is fed via the external air feed line 114 to the heat exchanger 116 and is heated there. At low external temperatures, for example lower than or equal to 15° C., pure gas 124 is fed additionally to the heat exchanger 116 via the first warm air feed line 120, in addition to the cooling region waste air 126. The pure gas which comes from a thermal afterburning operation has comparatively high temperatures in the range of 150° C. and can be mixed with a volumetric flow which is such that the external air 112 is heated to approximately 17° C. in counterflow by the plate heat exchanger 116. At said temperature, the external air 112 is fed via the cooling air discharge line 118 of the heat exchanger 116 to the feed air system 152 and, in the further course, via the cooling region feed line 158 to the cooling region 106. The inlet volumetric flow to the cooling region 106 is determined via the volumetric flow sensor 168. In this operating mode, the control valve 115 in the external air feed line 114 is open and the bypass control valve 144 is closed. The external air 112 is therefore heated by way of cooling region waste air 126 with pure gas 124 being mixed in, without energy for heating purposes being required from the technical supply network of the dryer 100.

At external air temperatures of higher than 17° C., the bypass control valve 114 is opened and the control valve 115 in the external air feed line 114 is closed. In this operating mode, the external air 112 is fed around the heat exchanger 116 directly into the cooling air discharge line 118 and therefore to the feed air system 152. Heating does not take place via the heat exchanger 116, with the result that further energy savings are possible.

The following volumetric flow conditions, for example, can occur during operation in an exemplary system:

Between 10 000 and 12 000 m³/h can be discharged at the pure gas discharge line 134, up to 62 000 m³/h can be discharged at the temperature control air discharge line, and up to 60 000 m³/h can be discharged at the cooling region waste air line. Up to 60 000 m³/h can be fed via the cooling air discharge line 118 of the heat exchanger 116 to the feed air system 152 and therefore also to the cooling region 106. Accordingly, up to 60 000 m³/h can be discharged via the waste air line 121 and can be fed via the second warm air feed line 122 to the heat exchanger. It is provided that up to 2000 m³/h can be fed via the first warm air feed line 120 to the heat exchanger. The pure gas 124 has, for example, a temperature of 150° C., whereas the temperature of the cooling region waste air 126 is approximately from 30° C. to 50° C. The external air which is fed to the cooling region should have a temperature of approximately from 17° C. to 35° C. in the cooling region feed line 158.

As a result of the energy-optimized fresh air heating, the cooling of the vehicle bodies 108 can take place virtually exclusively via fresh air 112. No condensation or scarcely any condensation accrues in the cooling region 106, since scarcely any recirculated air or no recirculated air circulates as a result of the feed/waste air operation and therefore no enrichment takes place. At the same time, the heating registers which are otherwise necessary with corresponding control, pipeline and insulation outlay can be dispensed with.

What is claimed is:

1. A device for controlling the temperature of objects comprising:
a) a temperature control space and a cooling region which is connected to the temperature control space,
b) a temperature control device for generating temperature control air,
c) a control device, and
d) a heat exchanger,
wherein
e) the heat exchanger has an external air feed line, a warm air feed line which is connected to the cooling region and/or the temperature control device, and a cooling air discharge line which is connected to the cooling region, and
f) the control device is set up to control the temperature of external air which is fed in via the external air feed line by way of warm air which is fed in via the warm air feed line.

2. The device as claimed in claim 1, wherein the heat exchanger has a bypass line which connects the external air feed line and the cooling air discharge line.

3. The device as claimed in claim 2, wherein the bypass line has a control valve.

4. The device as claimed in claim 2, wherein the control device is set up to actuate the bypass line in a manner which is dependent on the temperature of the external air.

5. The device as claimed in claim 1, wherein the warm air is a pure gas of a thermal afterburning operation, cooling region waste air, direct temperature control space waste air and/or temperature control space waste air which is temperature controlled by way of the temperature control device.

6. The device as claimed in claim 1 further comprising a feed air system for feeding feed air to the cooling region, the feed air system being connected to the cooling air discharge line of the heat exchanger.

7. The device as claimed in claim 6, wherein the feed air system has a fan and/or a filter.

8. The device as claimed in claim 1, wherein the heat exchanger is configured as a plate heat exchanger.

9. The device as claimed in claim 1, wherein the heat exchanger has a temperature control air discharge line, via which the warm air which is fed to the heat exchanger can be output.

10. A method for controlling a device for controlling the temperature of objects, the method comprising the following steps:
a) determining of a temperature of external air;
b) setting of an external air volumetric flow through a cooling air discharge line, which external air volumetric flow can be temperature controlled via a heat exchanger; and
c) setting of a volumetric flow ratio between a volumetric flow which flows into the heat exchanger from a cooling region and a volumetric flow which flows into the heat exchanger from a temperature control device in a manner which is dependent on the temperature of the external air, wherein
a device controlled comprises a temperature control space, the cooling region which is connected to the temperature control space, the temperature control device for generating temperature controlled temperature control space air, and the heat exchanger which has an external air feed line, a warm air feed line which is connected to the cooling region and the temperature control device, and the cooling air discharge line which is connected to the cooling region.

11. The method as claimed in claim 10, further comprising the step:
deflecting of the external air volumetric flow around the heat exchanger through a bypass line in a manner which is dependent on the temperature of the external air.

12. The method as claimed in claim 11, further comprising the step of deflecting comprising complete deflection at a threshold temperature.
